(19) United States
(12) Patent Application Publication
(10) Pub. No.: US 2003/0218344 A1
(43) Pub. Date: Nov. 27, 2003

(54) Ultimate grip

(76) Inventor: John Olin Garrett, Midlothian, VA (US)

Correspondence Address: John Olin Garrett, 2039 Albion Road, Midlothian, VA, 23113, US

(21) Appl. No.: 10/412,989

(22) Filed: Apr. 14, 2003

Related U.S. Application Data
(60) Provisional application No. 60/374,466, filed on Apr. 22, 2002.

(51) Int. Cl. B65G 7/12

(52) U.S. Cl. 294/25

(57) ABSTRACT

Ultimate grip is a universal gripping device developed for the use of securing a striking implement to fingers by sliding fingers into finger element and wrapping end strap around object in a beneficial locking pattern and applying palmar side of hand onto grip and wrapped striking implement. The gripping device has a finger element which consist of flexor straps, metacarpal straps, metacarpophalangeal joint strap and an end strap used for wrapping around striking implement. The unique form of gripping device allows for flexor areas in the finger through palm side of hand to be permanently attached to striking implement by use of a securely locked end strap. Also, the unique form of gripping device allows for striking implement to fit securely in metacarpal and metacarpophalangeal joints of finger and palm providing a consistent flexible grip which is extremely important in proper handling technique of a striking implement such as a bat, club or racquet. The ability to wrap end strap in a clockwise or counterclockwise direction forming a locking pattern on striking implement will eliminate any slipping or vibration between striking implement and palmar side of hand. Once a proper grip and wrap has been performed, ultimate grip will provide user with increased athletic swinging technique, hand protection, padding, comfort, durability, hand coordination, muscle memory and superior gripping performance.

### CROSS REFERENCE TO RELATED APPLICATIONS

NOT APPLICABLE

### STATEMENT OF FEDERALLY SPONSORED RESEARCH/DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to a universal gripping device used for securing an object to finger or fingers by wrapping end strap around object in a beneficial pattern, locking end strap and then applying hand to object for a maximum hold. More particularly, this invention relates to uniquely formed gripping device developed for superior gripping ability, hand protection, padding, physical hand enhancement, comfort, hand and eye coordination, muscle memory, weight lifting, athletic performance and can be used by individuals who have physical disabilities in relation to the hand. This group of individuals would include members who have lost a thumb or finger in an accident, born with partial finger or fingers, prosthetic hand, arthritis and other syndromes that plaque the hand. Ultimate grip can be used in a wide variety of sporting activities requiring the use of a bat, club, pole or racquet. Just to mention several sports were ultimate grip would benefit an individual would be golf, baseball, softball, tennis, racquetball, trophy game fishing, lacrosse, field hockey, etc. More importantly, ultimate grip has been developed to aid the hand in gripping, pulling, pushing, swinging, slashing, picking up objects and even holding onto objects with a no slip sure grip performance. The development of products to aid the hand when holding onto a bat, club, pole or racquet is well documented in previous art. The glove is most commonly worn by athletes participating in various sports to enhance the participants grip. The glove has evolved over the past few decades to include gripping apparatus made out of leather, polymers and silicon resins, moulds with ridges to reduce vibration, protection pads, foams and cells for comfort, custom designed fasten strips to strengthen glove and swinging attachments to better serve the hand of an individual when participating in sporting activities. U.S. Pat. No. 5,117,509 describes a sporting glove whose palm portion is made out of a sheet of leather material prepared by a chrome tanning process with a reduced oil content, wherein a uniformly thin layer of silicone sealant is bonded to the entire palm piece, so as to penetrate partially into the sheet of leather material and form a continuous coating throughout the palm piece. U.S. Pat. No. 6,052,827 explains how vibration reducing pads are coupled to the interior of the glove in critical locations for reducing the degree of vibration. U.S. Pat. No. 6,216,276 describes a glove which embodies a flexible athletic glove consisting of a palmar side and dorsal side. A plurality of finger portions and a thumb portion, each having a palmar and dorsal side, attached to the glove body. A first resilient pad along with other resilient pads, comprising silicon foam, are constructively attached to palmar side of the glove body. U.S. Pat. No. 5,490,290 is an improved design for an open fingered glove. This invention uses connector strips made of lycra, leather, or other traditional materials to enhance the stability of the glove. The connector strips connect the sides of each finger from the palm part to the back part at a location proximate to the tip of each finger and running to a point short of the crotch of each finger. The improved design allows for structural integrity to be maintained while permitting an opening to exist at the crotch of each finger, thereby providing for increased cooling of the hand. U.S. Pat. No. 5,588,651 generally relates to a hand accessories useful for improving power transmission and improving control of swinging movement between the hands and the handle of a striking implement such as a bat, club, racquet, thereby transmitting a greater amount of power and control of flight of a ball that is struck with a bat or club. Proper gripping technique of a bat, club or racquet requires a user to grip handle with fingers firmly with sufficient spacing between palm and handle so index, middle, ring fingers of the hand are primarily used for gripping handle allowing for hand to securely grasp striking implement. The human hand has a difficult time gripping round thin objects like a bat, club or racquet due to the concave structure of the palm. In a swinging, pulling, pushing motion it is difficult to maintain a grip because inertia will cause handle to wobble, fall backwards out of fingers into the web between index metacarpophalangeal joint and thumb metacarpophalangeal joint when handle is being propelled forward in swinging motion. As the bat handle is forced momentarily from the fingers back to the web area of skin, the user will lose control and response, causing swinging implement to become unstable in hand. More importantly, just before and even after impact, handle will return to the fingers as it catches up to the forward motion of the hand resulting in a loss of control and power in swing. The pivoting vibration of the handle in hand before and after contact will cause user to have an inferior striking performance. The human hand also has difficulty gripping a bat, club or racquet in various moisture conditions, inevitably saturating surface of hand thus causing moisture between hand and handle of striking implement. While these improvements and additional assemblies to the glove fulfill their respective, particular objectives and requirements, the aforementioned patents do not disclose a new and original gripping device which is superior in various modes of operation and function. In these respects, the ultimate grip substantially departs from conventional concepts and designs of the prior art, and in so doing provides a device developed to have a superior gripping performance.

### SUMMARY OF THE INVENTION

In view of the foregoing disadvantages inherently known in gloves, attachments and general gripping enhancement assemblies present in prior art, ultimate grip provides a new and original gripping device developed for securing objects such as striking implements to the hand with superior gripping ability, comfort and athletic performance. The general purpose of the ultimate grip is to provide user with an anti-slip device which will enhance many modes and functions of operation relating to gripping and using a striking implement. The ultimate grip is developed in form to have a finger element and a strap which is connected to finger element for the purpose of wrapping striking implement in a beneficial locking pattern allowing finger flexor network components, volar interosseous, phalanges, metacarpal, carpus, individual or group metacarpophalangeal joints and any combination thereof to be securely attached to striking implement. After striking implement has been wrapped accordingly with end strap and locked, fingers in conjunction with palmar side of hand will have a comfortable surface to grip swinging implement eliminating any wobbling, vibration and slippage between hand and handle. Ultimate grip also incorporates additional embodiments to assist user when swinging striking implement. These embodiments are associated with proper swinging techniques which are immediately realized once ultimate grip is attached and wrapped to striking implement. These additional embodiments include hand protection, padding, comfort, durability hand and eye coordination and most importantly the ability to place fingers, in conjunction with palm, the same way each and every time striking implement is gripped, allowing for muscle memory.

### BRIEF DESCRIPTION OF THE DRAWINGS

FIG. 1-A is a top isometric view of ultimate grip showing finger element with connected strap;

FIG. 1-B is a top view of ultimate grip;

FIG. 1-C is a bottom view of ultimate grip;

FIG. 1-D is a side view of ultimate grip

FIG. 1-E is a front view of ultimate grip

### DETAILED DESCRIPTION OF THE INVENTION

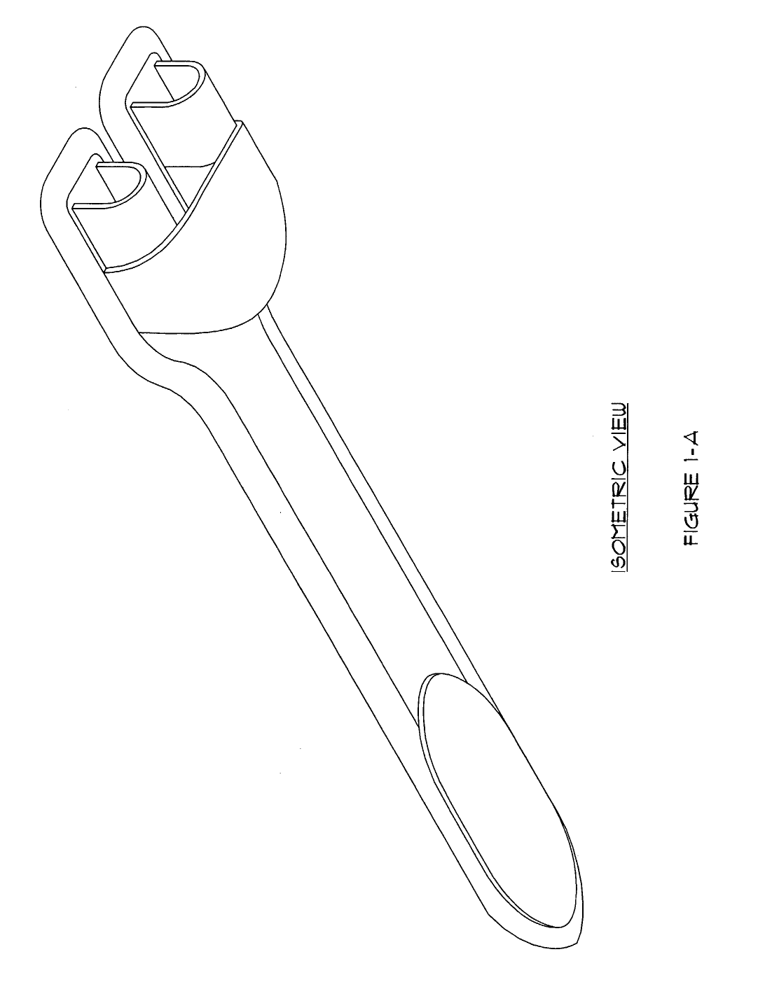

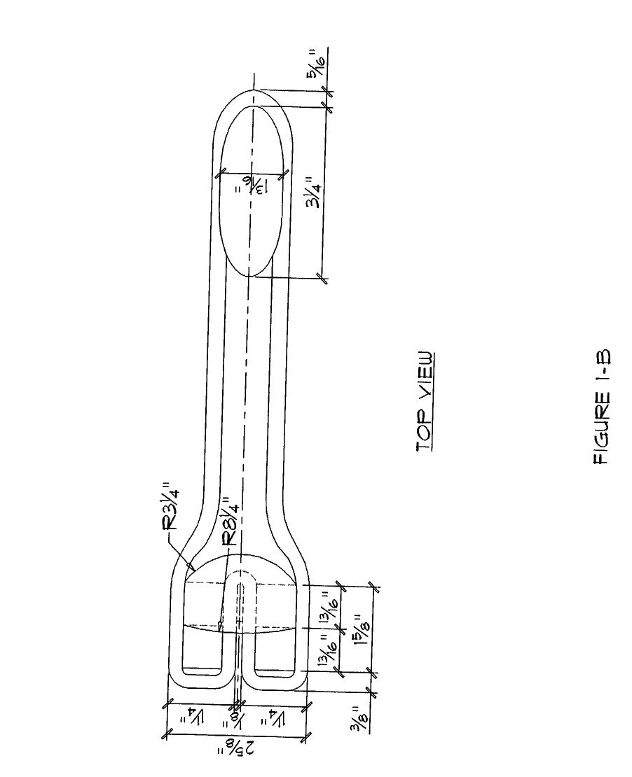

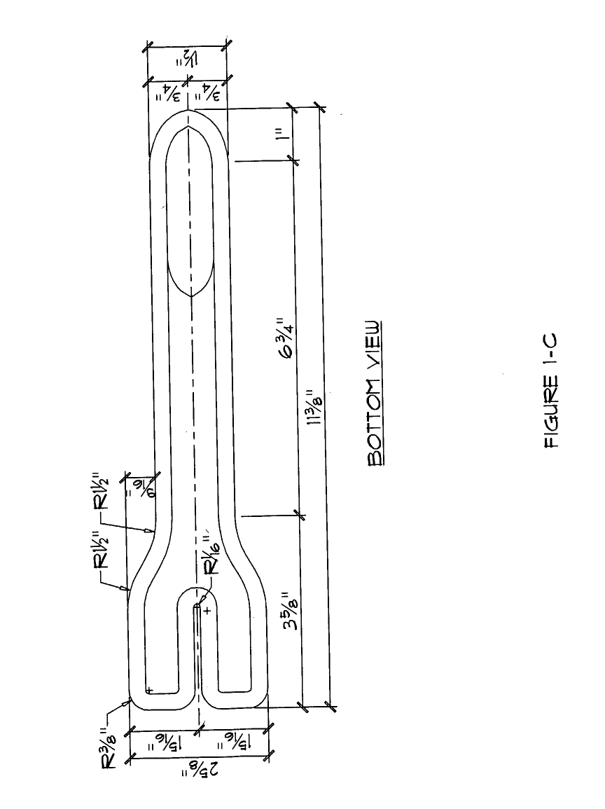

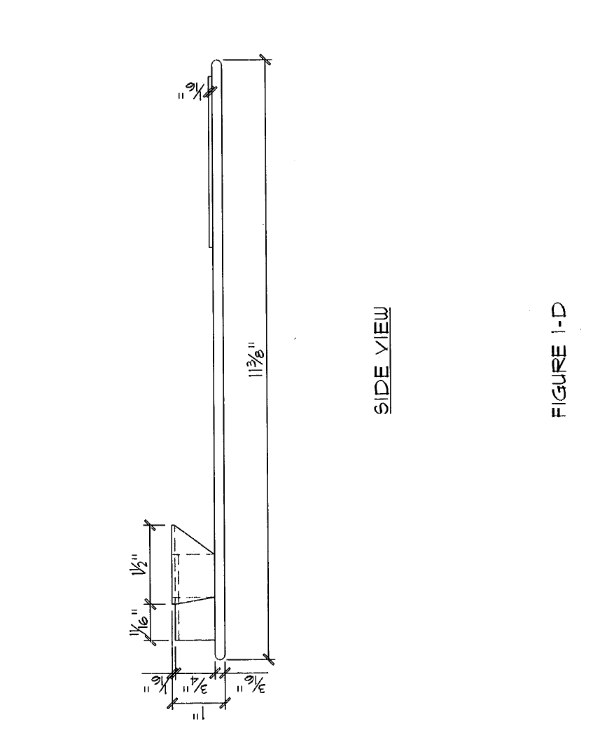

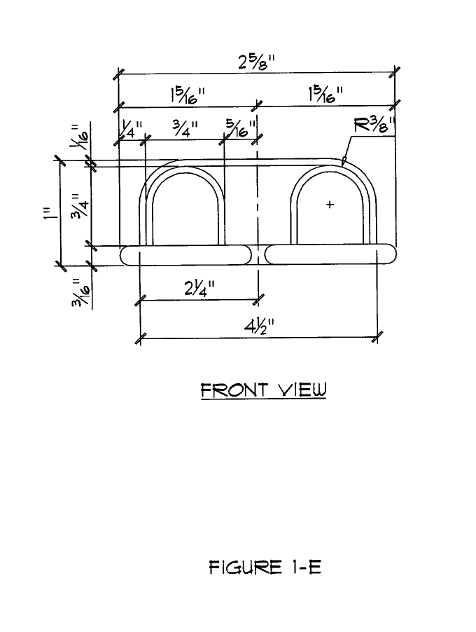

It has been determined through research, development and experimentation a universal gripping device needs to be formed with the ability of being attached to fingers in a advantageous design allowing for flexor, phalanges, metacarpal, metacarpophalangeal joints and any combination of, to flex securely while end strap has been locked in a secure pattern in relation to the palmar side of hand. FIG. 1-A shows a top isometric view of ultimate grip with the front end having a finger element in conjunction with flexor straps, metacarpal straps and a back end designated end strap. There is also a metacarpophalangeal joint strap overlapping flexor and metacarpal straps which secures dorsal side of finger and volar interosseous to left and right side of ultimate grip. The finger element in present design, but not limited too, incorporates a two finger design which will allow ultimate grip to be attached to any two fingers on left or right hand. Also, present finger element design allows for ultimate grip to be attached to a finger and a thumb. FIG. 1-B is a top view of ultimate grip which gives a detailed view of flexor straps, metacarpal straps and metacarpophalangeal strap. Finger element in present design uses two straps for each finger in which one strap will attach to flexor area in the tip of finger and the other strap to metacarpal area of finger. These straps in present design are 13/16 inches wide and will vary in construction depending on use and size of finger. The metacarpophalangeal joint strap is 3¼ inches wide giving more support to dorsal side of finger and hand. The straps are designed to fit comfortably to dorsal, volar interosseous and palmer side of finger. The ends of flexor straps, metacarpal straps and metacarpophalangeal joint strap will attach to bottom of ultimate grip. FIG. 1-C is a good view of bottom side of ultimate grip showing finger element and end strap. The bottom side of finger element measures 3⅝ inches wide and is similar in form to a horseshoe. The end strap measure 7¾ inches in length. The bottom side of ultimate grip will have surfaces made out of polymers, silicone and elastic materials for improving gripping performance. Another attachment at the back end of strap measures 3¼ inches in length which will be used as a locking and gripping pad. The bottom side of ultimate grip is given the name triton secure base design due to it's fork like form. The triton secure base can be formed or shaped using a single piece of material or several pieces of material varying in length and size which ever is most beneficial to design and use. The triton secure base is the first step taken in constructing ultimate grip. FIG. 1-D is a side view of ultimate grip showing flexor strap, metacarpal strap, metacarpophalangeal joint strap and securing pad which is located at back end of grip. The next step in constructing ultimate grip is to sew, glue or mold flexor strap, metacarpal strap and metacarpophalangeal joint strap to the bottom of ultimate grip. The last step in completing construction of ultimate grip is to sew securing pad at the back end, top side of triton secure base. FIG. 1-E is a front view of ultimate grip showing flexor strap and metacarpophalangeal joint strap which is designated front end of ultimate grip. There is a 1/16 inch spacing between finger element which allows the volar interosseous of finger to move independently of one and another providing flexibility while end strap is locked and secured to striking implement.

What is claimed is:

1. A gripping device comprising:
A new and original formed grip having a finger element located at front end of grip which attaches to finger with strap at the tip of finger designated flexor area and also attaching at metacarpal area with strap, securing metacarpophalangeal joint with strap covering phalanges and carpus having an end strap used to wrap around a striking implement allowing for palmar side of hand to fit securely to end strap and wrapped striking implement.

2. The gripping device of claim 1 wherein said finger element can be formed to fit a plurality of fingers.

3. The finger element in gripping device incorporating a flexor strap, metacarpal strap and metacarpophalangeal strap in which the ends of the foresaid straps attach to the bottom or top of gripping device whichever is most beneficial to use and design.

4. The gripping device of claim 1 wherein said finger element can be formed to fit deformed fingers, partial fingers or nub.

5. The gripping device of claim 1 wherein said finger element and end strap can be formed to fit a prosthetic hand.

6. The gripping device of claim 1 wherein the end strap can be made to have a variety of length for wrapping and locking purposes most beneficial to design and use.

7. The gripping device of claim 1 wherein the finger element and end strap can be formed to wrap around a striking implement or an object requiring end strap to be wrapped several times around striking implement forming a locking pattern and continuing around palmar and dorsal side of hand on to wrist and forearm for additional locking support.

8. The gripping device of claim 1 wherein end strap uses a clockwise wrapping and locking pattern.

9. The gripping device of claim 1 wherein end strap uses a counterclockwise wrapping and locking pattern.

10. The gripping device of claim 1 wherein the unique form of gripping device can have a top side and bottom side being named triton secure base design.

11. The gripping device of claim 10 having a top side and bottom side allowing for any beneficial material to be placed in between top side and bottom side.

12. The gripping device of claim 1 wherein the entire gripping device can be made out leather.

13. The gripping device of claim 1 wherein the entire gripping device can be made out of elastomers, polymers and other synthetic formed foam materials.

14. The gripping device of claim 1 wherein additional gripping pads can be strategically sewn to gripping device.

15. The gripping device and additional gripping pads of claim 14 wherein said pads can be of patterned silicone material formed and molded to gripping device.

16. The gripping device of claim 1 wherein additional alignment devices can be formed and molded to device in a predetermined positioning manner best arranged on device for consistent positioning of finger or fingers on device in relation to striking implement or object being used.

17. The gripping device and alignment device of said claim 16 wherein additional alignment devices can be sewn in a predetermined positioning manner on gripping device.

18. The gripping device of claim 1 wherein a plurality of ridges can be sewn on device for vibration eliminating purposes.

19. The gripping device and ridges of claim 18 wherein ridges can be formed and molded to device for vibration eliminating purposes.
